(19) United States
(12) Patent Application Publication
(10) Pub. No.: US 2017/0232822 A1
(43) Pub. Date: Aug. 17, 2017

(54) EJECTOR-TYPE REFRIGERATION CYCLE

(71) Applicant: DENSO CORPORATION, Kariya-city, Aichi-pref. (JP)

(72) Inventors: Isamu TAKASUGI, Kariya-city (JP); Hiroshi KATAOKA, Kariya-city (JP); Haruyuki NISHIJIMA, Kariya-city (JP); Yoshiyuki YOKOYAMA, Kariya-city (JP); Youhei NAGANO, Kariya-city (JP)

(21) Appl. No.: 15/502,631

(22) PCT Filed: Aug. 7, 2015
(86) PCT No.: PCT/JP2015/003980

§ 371 Date: Feb. 8, 2017

(30) Foreign Application Priority Data
Aug. 28, 2014 (JP) 2014-173727

(51) Int. Cl. B60H 1/32

(52) U.S. Cl. CPC B60H 1/3229; B60H 1/3204; B60H 2001/3298; B60H 2001/3297

(57) ABSTRACT

An ejector-type refrigeration cycle includes an ejector module integrated with a gas-liquid separation device. The ejector module is disposed outside an area that overlaps with an engine when viewed from a vehicular upper side. Further, the ejector module may be disposed outside an area overlapping with the engine when viewed from the vehicular front side, and the ejector module may be disposed outside of side members in a vehicle width direction.

### CROSS REFERENCE TO RELATED APPLICATION

This application is based on and incorporates herein by reference Japanese Patent Application No. 2014-173727 filed on Aug. 28, 2014.

### TECHNICAL FIELD

The present disclosure relates to an ejector-type refrigeration cycle having an ejector as a refrigerant depressurizing device.

### BACKGROUND ART

Up to now, an ejector-type refrigeration cycle that is a vapor compression refrigeration cycle device having an ejector as a refrigerant depressurizing device has been known.

In the ejector-type refrigeration cycle of this type, a refrigerant that has flowed out of an evaporator is drawn from a refrigerant suction port of the ejector due to a suction action of an ejection refrigerant ejected at high speed from a nozzle portion of the ejector, and a pressure of a refrigerant mixture of the ejection refrigerant and the drawn refrigerant is increased by a diffuser portion (pressure increase portion) of the ejector, and then drawn into a compressor.

With the above configuration, in the ejector-type refrigeration cycle, a pressure of the drawn refrigerant can be increased more than the pressure of the drawn refrigerant in a normal refrigeration cycle device in which a refrigerant evaporation pressure in an evaporator is substantially equal to a pressure of the intake refrigerant to be drawn into the compressor. Therefore, in the ejector-type refrigeration cycle, a coefficient of performance (COP) of the cycle can be improved while a power consumption of the compressor is reduced.

Further, Patent Document 1 discloses an ejector (hereinafter referred to as “ejector module”) integrated with a gas-liquid separation device (gas-liquid separation portion).

According to the ejector module of Patent Document 1, a suction side of the compressor is connected to a gas-phase refrigerant outflow port through which a gas-phase refrigerant separated by the gas-liquid separation device flows out. A refrigerant inflow port side of the evaporator is connected to a liquid-phase refrigerant outflow port through which a liquid-phase refrigerant separated by the gas-liquid separation device flows out. Further, a refrigerant outflow port side of the evaporator is connected to the refrigerant suction port, thereby being capable of extremely easily configuring the ejector-type refrigeration cycle.

However, in the ejector module of Patent Document 1, since the gas-liquid separation device is integrated together, the liquid-phase refrigerant separated by the gas-liquid separation device is likely to absorb a heat from the external when the ejector module is placed under a high-temperature environment.

For example, in the ejector-type refrigeration cycle applied to the vehicle, the liquid-phase refrigerant separated by the gas-liquid separation device is likely to absorb a heat within the engine room when the ejector module is disposed in the engine room. Then, the liquid-phase refrigerant separated by the gas-liquid separation device absorbs the heat within the engine room, and an enthalpy of the refrigerant to flow into the evaporator rises. There is a risk that a refrigeration performance delivered by the evaporator may decrease.

### PRIOR ART DOCUMENT

### Patent Document

Patent Document 1: JP 2013-177879 A

### SUMMARY

The present disclosure has been made in view of the above points, and an object of the present disclosure is to provide an ejector-type refrigeration cycle which is applied to a vehicle and capable of suppressing a reduction in refrigeration performance delivered by an evaporator.

An ejector-type refrigeration cycle for a vehicle includes a compressor, a radiator, an ejector module having a body portion, and an evaporator. The compressor compresses and discharges a refrigerant, and the radiator radiates heat of the refrigerant discharged from the compressor. The body portion includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; and a gas-liquid separation portion which separates the refrigerant that has flowed out of the pressure increase portion into gas and liquid. The evaporator evaporates a liquid-phase refrigerant separated by the gas-liquid separation portion. The compressor and the radiator are disposed in an engine room that is positioned outside a vehicle compartment and is a space in which an internal combustion engine is disposed. The evaporator is disposed in the vehicle compartment. The ejector module is disposed outside an area that overlaps with the internal combustion engine when viewed from a vehicular upper side.

In this example, the internal combustion engine generates heat and its temperature becomes high at the time of operation. Thus, a temperature of an ambient air of the internal combustion engine is also likely to increase. In addition, in an engine room of a vehicle, since the air heated by a waste heat of the internal combustion engine is likely to move upward, a temperature of a space of an upper side of the internal combustion engine is likely to increase.

With respect to this, according to the above first aspect, since the ejector module is disposed outside an area that overlaps with the internal combustion engine when viewed from a vehicular upper side, absorption of the waste heat of the internal combustion engine by the liquid-phase refrigerant separated by the gas-liquid separation portion can be reduced. Therefore, a reduction in the refrigeration performance delivered by the evaporator can be suppressed.

According to a second aspect of the present disclosure, an ejector-type refrigeration cycle for a vehicle includes a compressor, a radiator, an ejector module having a body portion, and an evaporator. The compressor compresses and discharges a refrigerant, and the radiator radiates heat of the refrigerant discharged from the compressor. The body portion includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; and a gas-liquid separation portion which separates the refrigerant that has flowed out of the pressure increase portion into gas and liquid. The evaporator evaporates a liquid-phase refrigerant separated by the gas-liquid separation portion. The compressor and the radiator are disposed in an engine room that is positioned outside a vehicle compartment and is a space in which an internal combustion engine is disposed. The evaporator is disposed in a vehicle compartment. The ejector module is disposed outside an area that overlaps with the internal combustion engine when viewed from a vehicular front side. In this situation, in the engine room when the vehicle is traveling, the air heated by the waste heat of the internal combustion engine is likely to move backward due to a ram pressure (traveling wind pressure). Therefore, the temperature in the space at the rear of the internal combustion engine is likely to increase.

With respect to this, according to the above second aspect, since the ejector module is disposed outside an area that overlaps with the internal combustion engine when viewed from a vehicular front side, the absorption of the waste heat of the internal combustion engine by the liquid-phase refrigerant separated by the gas-liquid separation portion can be reduced. Therefore, a reduction in the refrigeration performance delivered by the evaporator can be suppressed.

According to a third aspect of the present disclosure, an ejector-type refrigeration cycle for a vehicle includes a compressor, a radiator, an ejector module having a body portion, and an evaporator. The compressor compresses and discharges a refrigerant, and the radiator radiates heat of the refrigerant discharged from the compressor. The body portion includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; and a gas-liquid separation portion which separates the refrigerant that has flowed out of the pressure increase portion into gas and liquid. The evaporator evaporates a liquid-phase refrigerant separated by the gas-liquid separation portion. The compressor and the radiator are disposed in an engine room that is positioned outside a vehicle compartment and is a space in which an internal combustion engine is disposed. The evaporator is disposed in the vehicle compartment. The ejector module is disposed at a position farther from the exhaust pipe than a surface of the internal combustion engine opposite from a side to which the exhaust pipe is attached, when viewed from a vehicular upper side.

In this situation, a high-temperature exhaust gas discharged from the internal combustion engine flows in an exhaust pipe of the internal combustion engine. Therefore, the temperature of the space around the exhaust pipe in the engine room is likely to increase.

With respect to this, according to the above third aspect, the ejector module is disposed at a position farther from the exhaust pipe than a surface of the internal combustion engine opposite from a side to which the exhaust pipe is attached, when viewed from the vehicular upper side. As a result, the absorption of the waste heat of the internal combustion engine by the liquid-phase refrigerant separated by the gas-liquid separation portion can be reduced. Therefore, a reduction in the refrigeration performance delivered by the evaporator can be suppressed.

Incidentally, the placement of the ejector module is not limited to the interior of the engine room. The ejector module may be placed in a space outside the vehicle compartment except for the engine room, or may be placed in the vehicle compartment.

### BRIEF DESCRIPTION OF THE DRAWINGS

FIG. 1 is a schematic diagram of an ejector-type refrigeration cycle according to a first embodiment of the present disclosure.

FIG. 2 is a schematic top view illustrating a placement of components of the ejector-type refrigeration cycle when a vehicle is viewed from above, according to the first embodiment.

FIG. 3 is a schematic front view illustrating a placement of the components of the ejector-type refrigeration cycle when the vehicle is viewed from front, according to the first embodiment.

FIG. 4 is a schematic top view illustrating a placement of components of the ejector-type refrigeration cycle when a vehicle is viewed from above, according to a second embodiment of the present disclosure.

FIG. 5 is a schematic diagram illustrating an arrangement of an ejector module according to a third embodiment of the present disclosure.

FIG. 6 is a schematic diagram illustrating a modification of the arrangement of the ejector module according to the third embodiment.

FIG. 7 is a schematic top view illustrating a placement of components of the ejector-type refrigeration cycle when a vehicle is viewed from above, according to a fourth embodiment of the present disclosure.

FIG. 8 is a schematic top view illustrating a placement of components of the ejector-type refrigeration cycle when a vehicle is viewed from above, according to a modification of the present disclosure.

### DESCRIPTION OF EMBODIMENTS

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

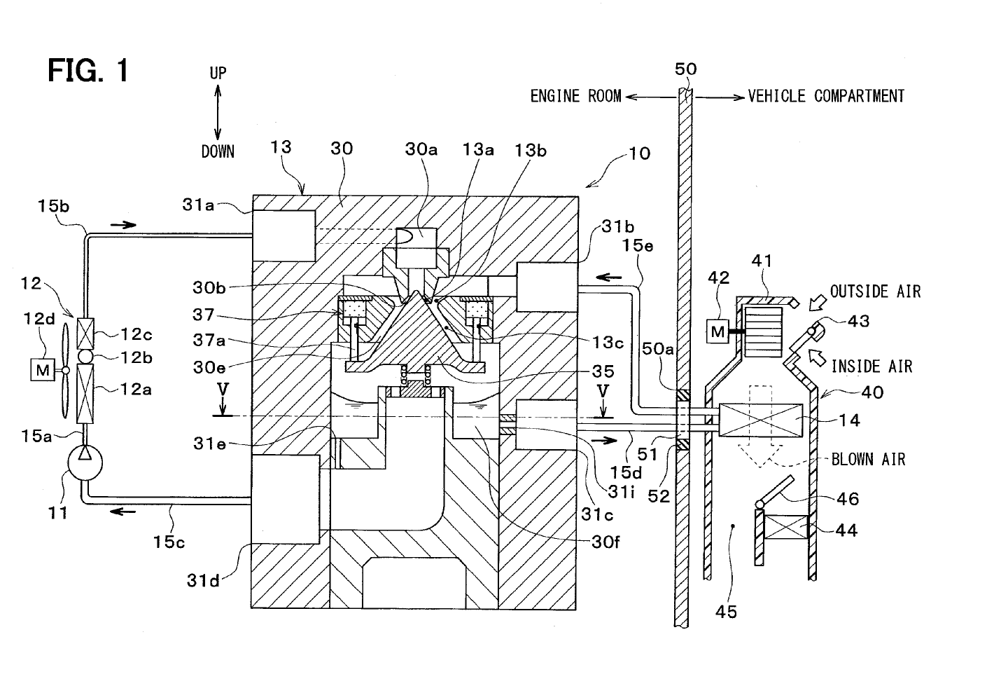

A first embodiment of the present disclosure will be described below with reference to FIGS. 1 to 3. Moreover, the ejector-type refrigeration cycle 10 according to the present embodiment is applied to a vehicle air conditioning apparatus, and performs a function of cooling a blown air to be blown into a vehicle compartment (vehicle interior space) that is an air-conditioning target space. Therefore, the cooling target fluid of the ejector-type refrigeration cycle 10 is the blown air.

The ejector-type refrigeration cycle 10 employs an HFC based refrigerant (specifically, R134a) as the refrigerant, and forms a subcritical refrigeration cycle in which a high-pressure side refrigerant pressure does not exceed a critical pressure of the refrigerant. The refrigeration cycle 10 may employ an HFO based refrigerant (specifically, R1234yf) or the like as the refrigerant. Furthermore, refrigerator oil for lubricating a compressor 11 is mixed in the refrigerant, and a part of the refrigerator oil circulates in the cycle together with the refrigerant.

First, a configuration of the ejector-type refrigeration cycle 10 will be described with reference to FIG. 1. In the ejector-type refrigeration cycle 10, the compressor 11 draws the refrigerant, pressurizes the refrigerant until the refrigerant becomes a high-pressure refrigerant, and discharges the pressurized refrigerant. The compressor 11 is disposed in an engine room 61 to be described later together with an internal combustion engine (engine) 70 which outputs a vehicle traveling driving force. The compressor 11 is driven by a rotational driving force output from the engine 70 through a pulley, a belt, and the like.

In more detail, in the present embodiment, the compressor 11 employs a variable capacity type compressor that is configured so that a refrigerant discharge capacity can be adjusted by changing a discharge volume. The discharge volume (refrigerant discharge capacity) of the compressor 11 is controlled according to a control current to be output to a discharge capacity control valve of the compressor 11 from a control device to be described later. A discharge port of the compressor 11 is connected with a refrigerant inflow port of a condensing portion 12a of a radiator 12 through an upstream side high-pressure pipe 15a.

The radiator 12 is a radiation heat exchanger that performs a heat exchange between the high-pressure refrigerant discharged from the compressor 11 and a vehicle exterior air (outside air) blown by a cooling fan 12d to radiate the heat from the high-pressure refrigerant and cool the high-pressure refrigerant. The radiator 12 is disposed on a front side of the vehicle in the engine room 61 together with a radiator 72 that radiates the heat from the engine coolant.

More specifically, the radiator 12 according to the present embodiment is configured as a so-called subcooling condenser including the condensing portion 12a, a receiver portion 12b, and a subcooling portion 12c. The condensing portion 12a performs the heat exchange between a high-pressure gas-phase refrigerant discharged from the compressor 11 and an outside air blown from the cooling fan 12d, and radiates the heat from the high-pressure gas-phase refrigerant to condense the high-pressure gas-phase refrigerant. The receiver portion 12b separates gas and liquid of the refrigerant that has flowed out of the condensing portion 12a and stores an excess liquid-phase refrigerant. The subcooling portion 12c performs the heat exchange between the liquid-phase refrigerant that has flowed out of the receiver portion 12b and the outside air blown from the cooling fan 12d and subcools the liquid-phase refrigerant.

The cooling fan 12d is an electric blower, a rotating speed (blown air amount) of which is controlled by a control voltage output from the control device.

Further, the cooling fan 12d blows an outside air toward both of the radiator 12 and the radiator 72. A refrigerant inflow port 31a of an ejector module 13 is connected to a refrigerant outflow port of the subcooling portion 12c of the radiator 12 through a downstream side high-pressure pipe 15b.

The ejector module 13 functions as a refrigerant depressurizing device for reducing a pressure of the high-pressure liquid-phase refrigerant of the subcooling state, which has flowed out of the radiator 12, and allowing the refrigerant to flow to the downstream side. The ejector module 13 also functions as a refrigerant circulating device (refrigerant transport device) for suctioning (transporting) the refrigerant that has flowed out of an evaporator 14 to be described later by the suction action of a refrigerant flow ejected at high speed to circulate the refrigerant. Further, the ejector module 13 according to the present embodiment functions as a gas-liquid separation device for separating the pressure-reduced refrigerant into gas and liquid.

In other words, the ejector module 13 according to the present embodiment is configured as an “ejector integrated with a gas-liquid separation device” or an “ejector with a gas-liquid separation function”. In the present embodiment, in order to clarify a difference from an ejector having no gas-liquid separation device (gas-liquid separation portion), a configuration in which the ejector is integrated (modularized) with the gas-liquid separation device is expressed by a term of “ejector module”.

The ejector module 13 according to the present embodiment is disposed in the engine room 61 together with the compressor 11 and the radiator 12. Incidentally, respective up and down arrows in FIG. 1 indicate up and down directions in a state where the ejector module 13 is mounted in the vehicle, and the respective up and down directions in a state where other components are mounted in the vehicle are not limited to the above arrows.

In more detail, as illustrated in FIG. 1, the ejector module 13 according to the present embodiment includes a body portion 30 configured by the combination of multiple components. The body portion 30 is made of a cylindrical metal member. The body portion 30 is provided with multiple refrigerant inflow ports and multiple internal spaces.

The multiple refrigerant inflow and outflow ports provided in the body portion 30 include a refrigerant inflow port 31a, a refrigerant suction port 31b, a liquid-phase refrigerant outflow port 31c, a gas-phase refrigerant outflow port 31d, and so on. The refrigerant inflow port 31a allows the refrigerant that has flowed out of the radiator 12 to flow into the body portion 30. The refrigerant suction port 31b draws the refrigerant that has flowed out of the evaporator 14. The liquid-phase refrigerant outflow port 31c allows the liquid-phase refrigerant separated by a gas-liquid separation space 30f provided in the body portion 30 to flow to the refrigerant inlet side of the evaporator 14. The gas-phase refrigerant outflow port 31d allows the gas-phase refrigerant separated by the gas-liquid separation space 30f to flow to the intake side of the compressor 11.

The internal space provided in the body portion 30 includes a swirling space 30a, a depressurizing space 30b, a pressurizing space 30e, the gas-liquid separation space 30f, and so on. The swirling space 30a swirls the refrigerant that has flowed from the refrigerant inflow port 31a. The depressurizing space 30b reduces the pressure of the refrigerant that has flowed out of the swirling space 30a. The pressurizing space 30e allows the refrigerant that has flowed out of the depressurizing space 30b to flow into the pressurizing space 30e. The gas-liquid separation space 30f separates the refrigerant that has flowed out of the pressurizing space 30e into gas and liquid.

The swirling space 30a and the gas-liquid separation space 30f are each shaped into a substantially cylindrical rotating body. The depressurizing space 30b and the pressurizing space 30e are each shaped into a substantially truncated cone-shaped rotating body that gradually expands toward the gas-liquid separation space 30f side from the swirling space 30a side. All of the center axes of those spaces are disposed coaxially. Meanwhile, the rotating body shape is a solid shape formed by rotating a top view around one straight line (center axis) coplanar with the plane figure.

Further, the body portion 30 is provided with a suction passage 13b, and the suction passage 13b introduces the refrigerant drawn from the refrigerant suction port 31b to a downstream side of the depressurizing space 30b in the refrigerant flow and an upstream side of the pressurizing space 30e in the refrigerant flow.

A passage formation member 35 is disposed in the depressurizing space 30b and the pressurizing space 30e. The passage formation member 35 is formed in an approximately cone shape which gradually expands more toward an outer peripheral side with distance from the depressurizing space 30b, and a center axis of the passage formation member 35 is also disposed coaxially with the center axis of the depressurizing space 30b and so on.

A refrigerant passage is provided between an inner peripheral surface of a portion providing the depressurizing space 30b and the pressurizing space 30e of the body portion 30 and a conical side surface of the passage formation member 35. A shape of an axial vertical cross-section of the refrigerant passage is annular (a donut shape in which a small-diameter circular shape coaxially disposed is removed from a circular shape).

In the above refrigerant passage, a refrigerant passage provided between a portion providing the depressurizing space 30b of the body portion 30 and a portion of the conical side surface of the passage formation member 35 on an apex side is shaped to narrow a passage cross-sectional area toward a refrigerant flow downstream side. With that shape, the refrigerant passage configures a nozzle passage 13a that functions as a nozzle portion which reduces the pressure of the refrigerant in an isentropic manner and ejects the refrigerant.

In more detail, the nozzle passage 13a according to the present embodiment is shaped to gradually reduce a passage cross-sectional area toward a minimum passage area portion from an inlet side of the nozzle passage 13a, and gradually expand the passage cross-sectional area from the minimum passage area portion toward an outlet side of the nozzle passage 13a. In other words, in the nozzle passage 13a according to the present embodiment, the refrigerant passage cross-sectional area is changed as in a so-called “Laval nozzle”.

A refrigerant passage provided between a portion forming the pressurizing space 30e of the body portion 30 and a downstream portion of the conical side surface of the passage formation member 35 is shaped to gradually expand the passage cross-sectional area toward the refrigerant flow downstream side. With that configuration, the refrigerant passage configures a diffuser passage 13c functioning as a diffuser portion (pressure increase portion) which mixes an ejection refrigerant ejected from the nozzle passage 13a with a drawn refrigerant drawn from refrigerant suction port 31b to increase the pressure.

An element 37 functioning as a drive device for displacing the passage formation member 35 to change the passage cross-sectional area of the minimum passage area portion of the nozzle passage 13a is disposed in the body portion 30. In more detail, the element 37 has a diaphragm that is displaced according to a temperature and a pressure of the refrigerant (that is, refrigerant flowing out of the evaporator 14) which flows in the suction passage 13b. The displacement of the diaphragm is transferred to the passage formation member 35 through an actuating bar 37a, to thereby displace the passage formation member 35 in a vertical direction.

Further, with an increase in the temperature (the degree of superheat) of the refrigerant flowing out of the evaporator 14, the element 37 displaces the passage formation member 35 in a direction of expanding the passage cross-sectional area of the minimum passage area portion (toward the lower side in the vertical direction). On the other hand, with a decrease in the temperature (the degree of superheat) of the refrigerant flowing out of the evaporator 14, the element 37 displaces the passage formation member 35 in a direction of reducing the passage cross-sectional area of the minimum passage area portion (toward the upper side of the vertical direction).

In the present embodiment, the element 37 displaces the passage formation member 35 according to the degree of superheating of the refrigerant flowing out of the evaporator 14 as described above. As a result, the passage cross-sectional area of the minimum passage area portion of the nozzle passage 13a is adjusted so that the degree of superheating of the refrigerant present on the outlet side of the evaporator 14 comes closer to a predetermined reference superheat degree.

The gas-liquid separation space 30f is disposed on a lower side of the passage formation member 35. The gas-liquid separation space 30f configures a gas-liquid separation portion of a centrifugation type which swirls the refrigerant that has flowed out of the diffuser passage 13c around a center axis and separates gas and liquid of the refrigerant by the action of a centrifugal force. Further, the gas-liquid separation space 30f has an internal capacity insufficient to substantially accumulate an excessive refrigerant even if a load is varied in the cycle, and the refrigerant circulation flow rate that is circulated in the cycle is varied.

In addition, an oil return hole 31e is provided in a portion defining a bottom surface of the gas-liquid separation space 30f in the body portion 30. The oil return hole 31e returns the refrigerator oil in the separated liquid-phase refrigerant to a gas-phase refrigerant passage side that connects the gas-liquid separation space 30f to the gas-phase refrigerant outflow port 31d. In addition, an orifice 31i is disposed in the liquid-phase refrigerant passage that connects the gas-liquid separation space 30f to the liquid-phase refrigerant outflow port 31c. The orifice 31i functions as a depressurizing device for reducing the pressure of the refrigerant that is allowed to flow into the evaporator 14.

The gas-phase refrigerant outflow port 31d of the ejector module 13 is connected with an intake port of the compressor 11 through an intake pipe 15c. On the other hand, the liquid-phase refrigerant outflow port 31c is connected with a refrigerant inflow port of the evaporator 14 through the inlet pipe 15d.

The evaporator 14 is a heat-absorbing heat exchanger that performs a heat exchange between the low-pressure refrigerant depressurized by the ejector module 13 and the blown air that is blown into the vehicle compartment from a blower 42, to thereby evaporate the low-pressure refrigerant and exert a heat absorbing effect. The evaporator 14 is disposed in a casing 41 of a vehicle interior air conditioning unit 40 to be described later. Since the vehicle interior air conditioning unit 40 is disposed in the vehicle compartment, the evaporator 14 is also disposed in the vehicle compartment. The refrigerant outflow port of the evaporator 14 is connected with the refrigerant suction port 31b of the ejector module 13 through an outlet pipe 15e.

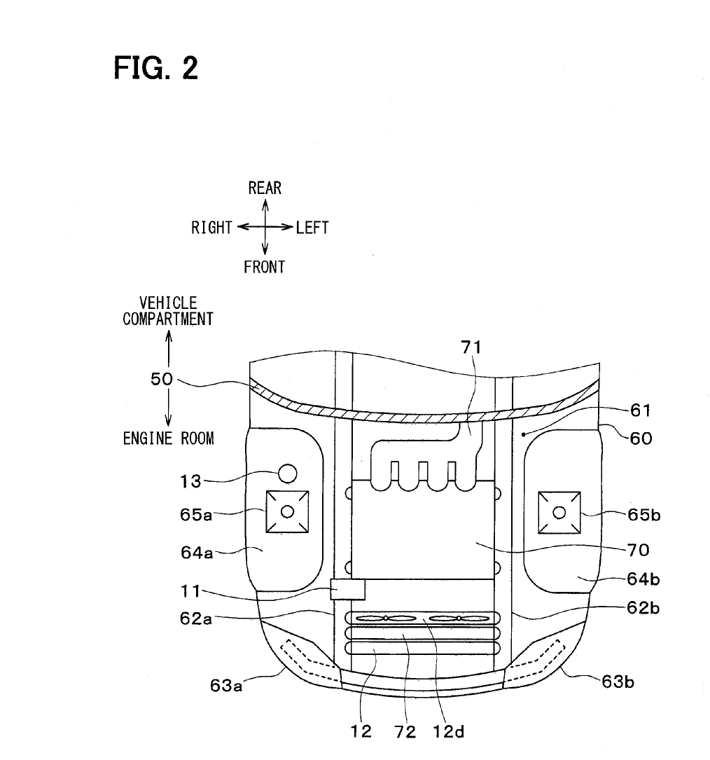

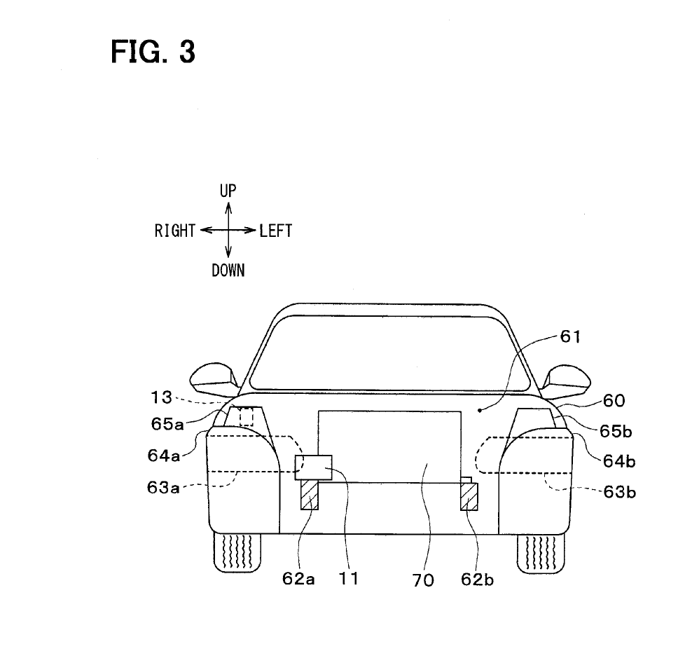

Next, a placement manner of the respective components of the ejector-type refrigeration cycle 10 will be described with reference to FIGS. 2 and 3. First, the engine room 61 in which the compressor 11 and so on are disposed will be described. The engine room 61 is a space outside the vehicle compartment in which the engine 70 is housed and, which is surrounded by a vehicle body 60, a fire wall 50 to be described later. The engine room 61 may be also called “engine compartment”.

A pair of side members (right side member 62a, left side member 62b) is disposed in the engine room 61. Those side members 62a and 62b are structural members configuring a part of the vehicle frame, and extend in a front-rear direction of the vehicle. Those side members 62a and 62b may be called “main frame”.

The engine 70 is fixed to the pair of side members 62a and 62b. In more detail, the engine 70 is disposed between the right side member 62a and the left side member 62b so as to be placed substantially in the center of the engine room 61 when viewed from the upper side and the front side of the vehicle.

Since the vehicle according to the present embodiment is configured as a front wheel drive type vehicle, the engine 70 is disposed in a state where a crankshaft of the engine 70 extends in a vehicle width direction. Further, the engine 70 according to the present embodiment is configured as a rear exhaust type engine. Therefore, an exhaust pipe (exhaust manifold) 71 allowing the exhaust gas of the engine 70 to be discharged is connected to a surface of the engine 70 on the vehicle rear side when viewed from the vehicular upper side.

The compressor 11 is fixed to a front right side of the engine 70 in the engine room 61. As described above, since a rotational driving force is transmitted to the compressor 11 from the engine 70 through a pulley, a belt, and so on, the compressor 11 may be fixed to the engine 70, or may be fixed to the side members 62a and 62b or the like and placed in the vicinity of the engine 70.

The radiator 12 is disposed in front of the engine 70 and between right and left headlights (specifically, right headlight 63a, left headlight 63b), together with the radiator 72 and the cooling fan 12d. Further, the radiator 12 is disposed on an outside air flow upstream side of the radiator 72.

The ejector module 13 is disposed in the vicinity of a suspension tower (in the present embodiment, right suspension tower) 65a and on the rear of the suspension tower 65a. Further, the suspension tower 65a is formed above a tire house (in the present embodiment, right tire house) 64a providing a housing space in which a vehicle front wheel is housed, and configures a mounting portion to which a vibration suppression device (shock absorber or the like) for suppressing vibration to be transmitted from the wheel to the vehicle is fitted.

In more detail, in the present embodiment, with the placement of the ejector module 13 in the vicinity of the suspension tower 65a, the ejector module 13 is disposed closer to the suspension tower 65a than the engine 70. Further, the ejector module 13 is disposed so that a shortest distance between the ejector module 13 and the suspension tower 65a falls within 10 cm.

With the above configuration, as illustrated in FIG. 2, the ejector module 13 according to the present embodiment is disposed outside an area overlapping with the engine 70 when viewed from the vehicular upper side. Further, as illustrated in FIG. 3, the ejector module 13 is disposed outside the area overlapping with the engine 70 and outside both of the side members 62a and 62b in the vehicle width direction when viewed from the vehicular front side.

In this example, the ejector module 13 may be fixed directly to the suspension tower 65a, or may be fixed indirectly to the suspension tower 65a through a bracket, a damping material or the like. In addition, the ejector module 13 may be located in the vicinity of the suspension tower 65a by connection to the downstream side high-pressure pipe 15b, the intake pipe 15c, the inlet pipe 15d, and the outlet pipe 15e without being fixed to the suspension tower 65a.

The evaporator 14 is disposed in the vehicle compartment. In this example, the vehicle of the present embodiment is equipped with the fire wall 50 as a partition plate that partitions the vehicle into the vehicle compartment and the engine room 61 outside the vehicle compartment. The fire wall 50 has a function of reducing a heat, noise, and so on to be transferred from the engine room 61 to the vehicle compartment, and may be called “dash panel”.

As illustrated in FIG. 1, the vehicle interior air conditioning unit 40 (evaporator 14) is disposed on the vehicle compartment side with respect to the fire wall 50. For that reason, the inlet pipe 15d and the outlet pipe 15e which connect the ejector module 13 to the evaporator 14 are disposed so as to penetrate through the fire wall 50.

In more detail, the fire wall 50 is provided with a circular or rectangular through hole 50a that penetrates between the engine room 61 side and the vehicle compartment side. The inlet pipe 15d and the outlet pipe 15e are connected to a connector 51 which is a connection metal member and integrated together. The inlet pipe 15d and the outlet pipe 15e are disposed to penetrate through the through hole 50a in a state where the inlet pipe 15d and the outlet pipe 15e are integrated together by the connector 51.

In this situation, the connector 51 is located on an inner peripheral side or in the vicinity of the through hole 50a. A packing 52 made of an elastic member is disposed in a gap provided between an outer peripheral side of the connector 51 and an opening edge of the through hole 50a. In the present embodiment, the packing 52 is made of ethylene propylene diene copolymer rubber (EPDM) that is a rubber material excellent in heat resistance.

The interposition of the packing 52 in the gap provided between the connector 51 and the through hole 50a reduces water, noise, and so on from being leaked into the vehicle compartment from the engine room 61 through the gap provided between the connector 51 and the through hole 50a.

Since the ejector module 13 according to the present embodiment is disposed at the rear side of the suspension tower 65a, the ejector module 13 is disposed closer to the evaporator 14 than the compressor 11. In other words, the shortest distance between the evaporator 14 and the ejector module 13 is shorter than the shortest distance between the compressor 11 and the ejector module 13. A length of the inlet pipe 15d is shorter than a length of the intake pipe 15c.

In this example, the length of the pipe in the present embodiment is a total length of a center line of the pipe shaped into a straight line or a curved line. Therefore, the length of the pipe can be expressed as a flow channel length. In addition, the pipe in the present embodiment is not limited to a tubular member, but includes a member providing a flow channel in which the refrigerant flows, which is formed in shapes other than the tubular shape as with the connector 51.

Subsequently, the vehicle interior air conditioning unit 40 will be described. The vehicle interior air conditioning unit 40 is used to blow the blown air, the temperature of which has been adjusted by the ejector-type refrigeration cycle 10. The vehicle interior air conditioning unit 40 is disposed inside a dashboard (instrument panel) positioned at the foremost portion in the vehicle compartment. Moreover, the vehicle interior air conditioning unit 40 is configured so that the blower 42, the evaporator 14, a heater core 44, an air mixture door 46, and so on are housed in the casing 41 forming an outer shell of the vehicle interior air conditioning unit 40.

The casing 41 is provided with an air passage for the blown air to be blown into the vehicle compartment, and is made of a resin (for example, polypropylene) that has a certain degree of elasticity and is also excellent in terms of strength. An inside and outside air switching device 43 is disposed on a most upstream side of the blown air flow in the casing 41 as an inside and outside air switching device that switchably introduces the inside air (vehicle interior air) and the outside air (vehicle exterior air) into the casing 41.

The inside and outside air switching device 43 continuously adjusts opening areas of an inside air introduction port for introducing the inside air into the casing 41, and an outside air introduction port for introducing the outside air into the casing 41 by an inside and outside air switching door to continuously change an air volume ratio of an air volume of an inside air and an air volume of an outside air. The inside and outside air switching door is driven by an electric actuator for the inside and outside air switching door, and the electric actuator is controlled in operation according to a control signal output from the control device.

The blower 42 is disposed on the blown air flow downstream side of the inside and outside air switching device 43. The blower 42 functions as a blowing device that blows the air taken through the inside and outside air switching device 43 toward the vehicle compartment. The blower 42 is an electric blower that drives a centrifugal multi-blade fan (sirocco fan) with the help of an electric motor, and is controlled in rotation speed (blown air amount) according to a control voltage output from the control device.

The evaporator 14 and the heater core 44 are disposed on the blown air flow downstream side of the blower 42, in the stated order along a flow of the blown air. In other words, the evaporator 14 is disposed on the blown air flow upstream side of the heater core 44. The heater core 44 is a heating heat exchanger that exchanges heat between an engine coolant and the blown air that has passed through the evaporator 14, and heats the blown air.

Further, a cold air bypass passage 45 is provided in the casing 41. The cold air bypass passage 45 allows the blown air having passed through the evaporator 14 to bypass the heater core 44 and flow to the downstream side. The air mixture door 46 is disposed on a blown air flow downstream side of the evaporator 14 and on the blown air flow upstream side of the heater core 44.

The air mixture door 46 is an air volume ratio adjusting device that adjusts an air volume ratio of an air passing through the heater core 34 and an air passing through the cold air bypass passage 45 in the air that has passed through the evaporator 14. The air mixture door 46 is driven by an electric actuator for driving the air mixture door, and the electric actuator is controlled in operation according to the control signal output from the control device.

A mixing space is provided on the air flow downstream side of the heater core 44 and on the air flow downstream side of the cold air bypass passage 45. The mixing space allows the air that has passed through the heater core 44 and the air that has passed through the cold air bypass passage 45 to be mixed together. Therefore, the air mixture door 46 adjusts an air volume ratio to adjust the temperature of the blown air (air conditioning wind) mixed in the mixing space.

In addition, an opening hole not shown is provided on the most downstream portion of the casing 41 in the blown air flow. The air conditioning wind mixed in the mixing space is blown through the opening hole into the vehicle compartment as an air-conditioning target space. Specifically, a face opening hole, a foot opening hole, and a defroster opening hole are provided as the opening holes. The face opening hole is provided for blowing the air conditioning wind toward an upper body of an occupant present in the vehicle compartment, the foot opening hole is provided for blowing the air conditioning wind toward feet of the occupant, and the defroster opening hole is provided for blowing the air conditioning wind toward an inner surface of a windshield of a vehicle.

The blown air flow downstream sides of the face opening hole, the foot opening hole, and the defroster opening hole are connected to a face blowing port, a foot blowing port, and a defroster blowing port (all of them are not shown), which are provided in the vehicle compartment, through ducts that form air passages, respectively.

Further, a face door that adjusts the opening area of the face opening hole, a foot door that adjusts the opening area of the foot opening hole, and a defroster door that adjusts the opening area of the defroster opening hole (all of them are not shown) are disposed on the blown air flow upstream sides of the face opening hole, the foot opening hole, and the defroster opening hole, respectively.

The face doors, the foot doors, and the defroster doors each configure an opening hole mode switching device for switching an opening hole mode, are coupled with electric actuators for driving the blowing port mode doors through link mechanisms, and rotationally operated in association with the electric actuators. Meanwhile, the operation of this electric actuator is also controlled by a control signal that is output from the control device.

The control device not shown includes a well-known microcomputer including a CPU, a ROM and a RAM, and peripheral circuits of the microcomputer. The control device controls the operation of the above-mentioned various electric actuators by performing various calculations and processing on the basis of a control program stored in the ROM.

Further, the control device is connected with an air conditioning control sensor set such as an inside air temperature sensor, an outside air temperature sensor, an insolation sensor, an evaporator temperature sensor, a coolant temperature sensor, a discharge pressure sensor. The control device receives detection values from the group of those sensors. The inside air temperature sensor detects a vehicle interior temperature (interior temperature) Tr. The outside air temperature sensor detects an outside air temperature Tam. The insolation sensor detects the amount of insolation As in the vehicle compartment. The evaporator temperature sensor detects the blowing air temperature from the evaporator 14 (the temperature of the evaporator) Tefin. The coolant temperature sensor detects a coolant temperature Tw of an engine 70 coolant flowing into the heater core 44. The discharge pressure sensor detects a pressure Pd of the high-pressure refrigerant discharged from the compressor 11.

Furthermore, an operation panel not shown, which is disposed in the vicinity of an instrument panel positioned at a front part in the vehicle compartment, is connected to the input side of the control device, and operation signals output from various operation switches mounted on the operation panel are input to the control device. An air conditioning operation switch that is used to perform air conditioning in the vehicle compartment, a vehicle interior temperature setting switch that is used to set a vehicle interior setting temperature Tset, and the like are provided as the various operation switches that are mounted on the operation panel.

Meanwhile, the control device of the present embodiment is integrated with a control unit for controlling the operations of various control target devices connected to the output side of the control device, but a configuration of the control device (hardware and software), which controls the operations of the respective control target devices forms the control unit of the respective control target devices. For example, in the present embodiment, a configuration which controls the actuation of the discharge capacity control valve of the compressor 11 configures a discharge capacity control unit.

Subsequently, the operation of the present embodiment having the above configuration will be described. In the vehicle air conditioning apparatus according to the present embodiment, when an air conditioning operation switch of the operation panel is turned on (ON), the control device executes an air conditioning control program stored in a storage circuit in advance.

The air conditioning control program reads the detection signals from the above air conditioning control sensor set, and the operation signals of the operation panel. Subsequently, the control device calculates a target blowing temperature TAO that is a target temperature of the air that is blown into the vehicle compartment on the basis of the read detection signals and the read operation signals.

The target blowing temperature TAO is calculated by Formula F1 below.

TAO=Kset*Tset−Kr*Tr−Kam*Tam−Ks*As+C (F1)

Meanwhile, Tset denotes a vehicle interior setting temperature that is set by the temperature setting switch, Tr denotes an interior temperature that is detected by the inside air temperature sensor, Tam denotes the outside air temperature that is detected by the outside air temperature sensor, and As denotes an amount of insolation that is detected by the insolation sensor. Kset, Kr, Kam, Ks denote control gains, and C denotes a constant for correction.

Further, the air conditioning control program determines operation states of the various control target devices connected to the output side of the control device on the basis of the calculated target blowing temperature TAO and the detection signals of the sensor group.

For example, the refrigerant discharge capacity of the compressor 11, that is, a control current to be output to the discharge capacity control valve of the compressor 11 is determined as described below. First, a target evaporator blowing temperature TEO of the blown air blown from the evaporator 14 is determined on the basis of the target blowing temperature TAO with reference to a control map that is stored in a storage circuit in advance.

Then, the control current to be output to the discharge capacity control valve of the compressor 11 is determined through a feedback control technique on the basis of a deviation between the evaporator temperature Tefin detected by the evaporator temperature sensor and the target evaporator blowing temperature TEO so that the evaporator temperature Tefin comes closer to the target evaporator blowing temperature TEO.

The rotation speed of the blower 42, that is, a control voltage to be output to the blower 42 is determined on the basis of the target blowing temperature TAO with reference to the control map stored in the storage circuit in advance. More specifically, the blown air amount is controlled to come close to a maximum amount with the control voltage to be output to the electric motor as a maximum in a cryogenic range of the target blowing temperature TAO (maximum cooling range) and an extremely high temperature range (maximum heating range), and the blown air amount is reduced more as the target blowing temperature TAO comes closer to an intermediate temperature range.

Also, an opening degree of the air mixture door 46, that is, a control signal to be output to the electric actuator for driving the air mixture door is determined so that the temperature of the blown air blown into the vehicle compartment comes closer to the target blowing temperature TAO on the basis of the evaporator temperature Tefin and the coolant temperature Tw.

Then, the control device outputs the control signal and so on determined as described above to the various control target devices. Thereafter, a control routine of reading the detection signals and the operation signals described above, calculating the target blowing temperature TAO, determining the operation states of the various control target devices, and outputting the control signal, and so on is repeated in the stated order for each predetermined control cycle until the actuation stop of the vehicle air conditioning apparatus is requested.

In this situation, in the ejector-type refrigeration cycle 10, the refrigerant flows as indicated by thick solid arrows in FIG. 1.

In other words, a high-temperature high-pressure refrigerant discharged from the compressor 11 flows into the condensing portion 12a of the radiator 12. The refrigerant that has flowed into the condensing portion 12a performs the heat exchange with the outside air blown from the cooling fan 12d, radiates the heat, and is condensed. The refrigerant condensed by the condensing portion 12a is separated into gas and liquid by the receiver portion 12b. A liquid-phase refrigerant, which has been subjected to gas-liquid separation in the receiver portion 12b, performs heat exchange with the outside air blown from the cooling fan 12d by the subcooling portion 12c, and radiates heat into a subcooled liquid-phase refrigerant.

The subcooled liquid-phase refrigerant that has flowed out of the subcooling portion 12c of the radiator 12 is isentropically depressurized by the nozzle passage 13a, and ejected. The nozzle passage 13a is defined between an inner peripheral surface of the depressurizing space 30b of the ejector module 13 and an outer peripheral surface of the passage formation member 35. In this situation, a refrigerant passage area of the depressurizing space 30b in the minimum passage area portion 30m is regulated so that the degree of superheating of the refrigerant on the outlet side of the evaporator 14 comes closer to a reference superheating degree.

The refrigerant that has flowed out of the evaporator 14 is drawn into the ejector module 13 from the refrigerant suction port 31b due to the suction action of the ejection refrigerant which has been ejected from the nozzle passage 13a. The ejection refrigerant ejected from the nozzle passage 13a and the drawn refrigerant drawn through the suction passage 13b flow into the diffuser passage 13c and join together.

In the diffuser passage 13c, a kinetic energy of the refrigerant is converted into a pressure energy due to an increase in a refrigerant passage area. As a result, a pressure of the mixed refrigerant is increased while the ejection refrigerant and the drawn refrigerant are mixed together. The refrigerant that has flowed out of the diffuser passage 13c is separated into gas and liquid in the gas-liquid separation space 30f. The liquid-phase refrigerant separated in the gas-liquid separation space 30f is reduced in pressure in the orifice 31i, and flows into the evaporator 14.

The refrigerant that has flowed into the evaporator 14 absorbs heat from the blown air blown by the blower 42, and evaporates. Accordingly, the blown air is cooled. On the other hand, the gas-phase refrigerant that has been separated in the gas-liquid separation space 30f flows out of the gas-phase refrigerant outflow port 31d, is drawn into the compressor 11, and again compressed.

The blown air cooled by the evaporator 14 flows into an air flow passage on the heater core 44 side and the cold air bypass passage 45 according to the opening degree of the air mixture door 46. The cold air that has flowed into the air flow passage on the heater core 44 side is again heated when passing through the heater core 44, and is mixed with the cold air that has passed through the cold air bypass passage 45 in the mixing space. Subsequently, the air conditioning wind adjusted in temperature in the mixing space is blown from the mixing space into the vehicle compartment via the respective blowing ports.

As described above, according to the vehicle air conditioning apparatus of the present embodiment, the air conditioning in the vehicle compartment can be performed. Further, according to the ejector-type refrigeration cycle 10 of the present embodiment, since the refrigerant pressurized by the diffuser passage 13c is drawn into the compressor 11, the drive power of the compressor 11 can be reduced to improve the cycle efficiency (COP).

Incidentally, in the ejector module 13 according to the present embodiment, since the gas-liquid separation space 30f is provided in the body portion 30, when the ejector module 13 is disposed in a high-temperature environment such as the engine room 61, the liquid-phase refrigerant separated by the gas-liquid separation space 30f is likely to absorb the heat in the engine room 61.

Then, the liquid-phase refrigerant separated by the gas-liquid separation space 30f absorbs the heat within the engine room 61, and when an enthalpy of the refrigerant to flow into the evaporator 14 is caused to rise, a refrigeration performance delivered by the evaporator 14 may be lowered.

On the contrary, in the ejector-type refrigeration cycle 10 according to the present embodiment, as described with reference to FIG. 2, the ejector module 13 is disposed outside the area overlapping with the engine 70 when viewed from the vehicular upper side. As a result, absorption of the heat in the engine room 61 by the liquid-phase refrigerant separated by a gas-liquid separation space 13f can be reduced.

In more detail, when the engine 70 generates a heat and becomes at high temperature at the time of actuation, a temperature of an ambient air of the engine 70 is also likely to increase. In addition, in the engine room 61 of the vehicle, since the air heated by a waste heat of the engine 70 is likely to move upward, a temperature of a space of an upper side of the engine 70 is likely to increase.

Therefore, with the placement of the ejector module 13 as in the present embodiment, absorption of the heat in the space on the upper side of the engine 70 by the liquid-phase refrigerant separated by the gas-liquid separation space 13f can be reduced. As a result, a reduction in the refrigeration performance delivered by the evaporator 14 can be suppressed.

In the ejector-type refrigeration cycle 10 according to the present embodiment, as described with reference to FIG. 3, the ejector module 13 is disposed outside the area overlapping with the engine 70 and outside the vehicle from both of the side members 62a and 62b when viewed from the vehicular front side. As a result, absorption of the heat in the engine room 61 by the liquid-phase refrigerant separated by a gas-liquid separation space 13f can be reduced.

In more detail, since the air heated by the waste heat of the engine 70 is likely to move backward due to the ram pressure (traveling wind pressure) when the vehicle is traveling, the temperature of a space of a rear side of the engine 70 is likely to increase. Further, in the present embodiment, since the radiator 72 is disposed on the front side of the engine 70, the temperature of a space on a front side of the engine is also likely to increase due to the heat radiated from the engine coolant.

Therefore, with the placement of the ejector module 13 as in the present embodiment, absorption of the heat in the space on the rear side or the front side of the engine 70 by the liquid-phase refrigerant separated by the gas-liquid separation space 13f can be reduced. As a result, a reduction in the refrigeration performance delivered by the evaporator 14 can be suppressed.

In addition, in the ejector-type refrigeration cycle 10 according to the present embodiment, since the ejector module 13 is disposed on the rear side of the suspension tower 65a, and the length of the inlet pipe 15d is shorter than the length of the intake pipe 15c, absorption of the heat in in the engine room 61 by the liquid-phase refrigerant separated by the gas-liquid separation space 30f can be reduced when the liquid-phase refrigerant flowing through the inlet pipe 15d. Therefore, a reduction in the refrigeration performance delivered by the evaporator 14 can be suppressed.

### Second Embodiment

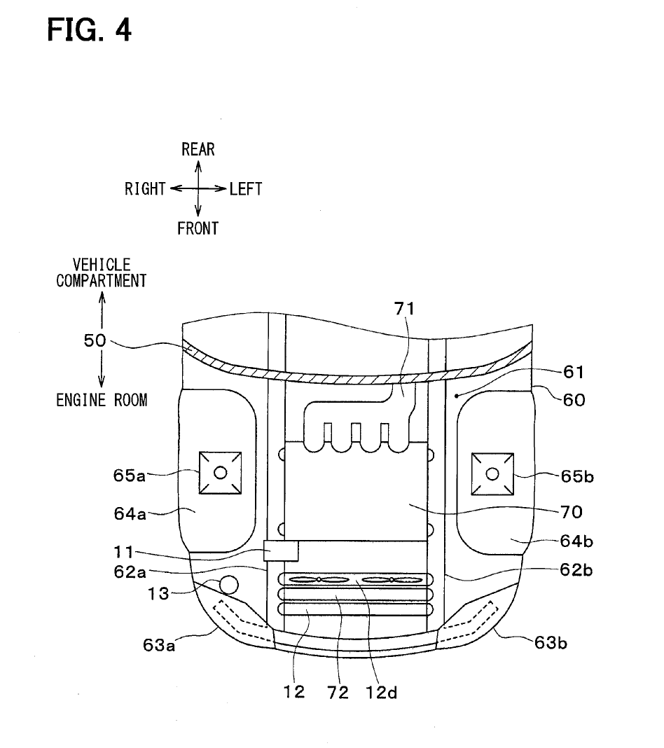

In the present embodiment, an example in which a placement manner of an ejector module 13 is changed from that in the first embodiment will be described. As illustrated in FIG. 4, the ejector module 13 according to the present embodiment is disposed on the rear side of the front headlight (specifically, the right headlight 63a), in more detail, on the rear side of a mounting portion of a reflector of the right headlight 63a formed on the vehicle body 60, and in the vicinity of the reflector.

Further, in the present embodiment, with the placement of the ejector module 13 in the vicinity of the reflector of the headlight, the ejector module 13 is disposed closer to the headlight than the engine 70. Further, the ejector module 13 is disposed so that the shortest distance between the ejector module 13 and the headlight falls within 10 cm.

With the above configuration, as illustrated in FIG. 4, the ejector module 13 according to the present embodiment is disposed at a position away from the exhaust pipe 71 more than a surface opposite to a side to which the exhaust pipe 71 is fitted in the engine 70 when viewed from the vehicular upper side.

Incidentally, the ejector module 13 may be fixed directly to the mounting portion of the reflector, or may be fixed indirectly to the mounting portion of the reflector through a bracket, a damping material or the like. In addition, the ejector module 13 may be located in the vicinity of the reflector of the headlight by connection to the downstream side high-pressure pipe 15b, the intake pipe 15c, the inlet pipe 15d, and the outlet pipe 15e without being fixed to the mounting portion of the reflector.

The other configurations of the ejector-type refrigeration cycle 10 are identical with those in the first embodiment. Therefore, when the vehicle air conditioning apparatus according to the present embodiment is actuated, the air conditioning in the vehicle compartment can be realized as in the first embodiment.

Further, according to the ejector-type refrigeration cycle 10 of the present embodiment, the ejector module 13 is disposed at a position away from the exhaust pipe 71 more than a surface opposite to a side to which the exhaust pipe 71 is fitted in the engine 70 when viewed from the vehicular upper side. As a result, absorption of the heat in the engine room 61 by the liquid-phase refrigerant separated by a gas-liquid separation space 13f can be reduced.

In more detail, since the high-temperature exhaust gas discharged from the engine 70 flows into the exhaust pipe 71 of the engine 70, the temperature of the space around the exhaust pipe 71 is likely to increase.

Therefore, with the placement of the ejector module 13 as in the present embodiment, absorption of the heat in the space around the exhaust pipe 71 of the engine 70 by the liquid-phase refrigerant separated by the gas-liquid separation space 13f can be reduced. As a result, a reduction in the refrigeration performance delivered by the evaporator 14 can be suppressed.

### Third Embodiment

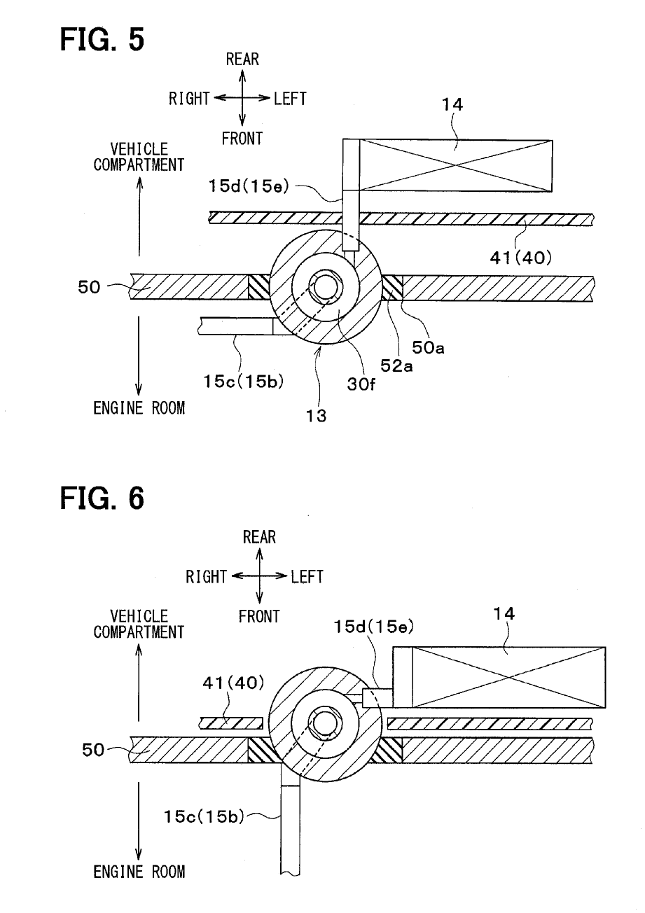

In the present embodiment, an example in which a placement manner of an ejector module 13 is changed from that in the first embodiment will be described. As illustrated in FIG. 5, the ejector module 13 according to the present embodiment is disposed on an inner peripheral side of a through hole 50a of a fire wall 50.

In more detail, one part of the ejector module 13 according to the present embodiment is disposed in an engine room 61 (vehicle exterior space) side, and another part of the ejector module 13 is disposed in a vehicle compartment (vehicle interior space) side. For that reason, the ejector module 13 according to the present embodiment is disposed closer to the fire wall 50 than the compressor 11. Further, an inlet pipe 15d and an outlet pipe 15e according to the present embodiment are disposed on the vehicle compartment (vehicle interior space) side.

FIG. 5 schematically illustrates a positional relationship of the ejector module 13, the fire wall 50, an evaporator 14, and so on. In addition, FIG. 5 illustrates the ejector module 13 in a reduced cross-sectional view taken along a cross-section V-V in FIG. 1. The same is applied to FIG. 6.

A packing 52a that performs the same function as that in the first embodiment is disposed in a gap between an outer peripheral side of the ejector module 13 and an opening edge of the through hole 50a. Therefore, in the present embodiment, a connector 51 is eliminated. Further, in the present embodiment, it can be expressed that the ejector module 13 is fixed to the fire wall 50 indirectly and swingably through a packing 52a.

It is needless to say that the ejector module 13 may be fixed directly to the fire wall 50 by bolt tightening or the like, or may be fixed indirectly to the fire wall 50 by a bracket or the like.

Further, in the present embodiment, as illustrated in FIG. 5, a portion of the intake pipe 15c on a side connected to the ejector module 13 (module side connection portion) and a module side connection portion of the downstream side high-pressure pipe 15b are disposed to overlap with each other when viewed in a vertical direction. The module side connection portion of the intake pipe 15c and the module side connection portion of the downstream side high-pressure pipe 15b are each shaped to extend along the fire wall 50.

In this example, the “shape to extend along the fire wall 50” is not limited to a shape extending perfectly in parallel to the fire wall 50, but includes a shape slightly deviated from the shape extending in parallel due to a manufacturing error or an assembling error. In addition, in the present embodiment, the module side connection portion of the outlet pipe 15e and the module side connection portion of the inlet pipe 15d are disposed to overlap with each other when viewed from the vertical direction.

The other configurations of the ejector-type refrigeration cycle 10 are identical with those in the first embodiment. Therefore, when the vehicle air conditioning apparatus according to the present embodiment is actuated, the air conditioning in the vehicle compartment can be realized as in the first embodiment.

Further, according to the ejector-type refrigeration cycle 10 of the present embodiment, since a part of the ejector module 13 is disposed in the vehicle compartment, absorption of the heat in the engine room 61 by the liquid-phase refrigerant separated by the gas-liquid separation space 30f in the ejector module 13 can be reduced. Further, since the inlet pipe 15d is disposed in the vehicle compartment, the liquid-phase refrigerant that flows in the inlet pipe 15d hardly absorbs the heat in the engine room 61. Therefore, a reduction in the refrigeration performance delivered by the evaporator 14 can be effectively suppressed.

In addition, according to the ejector-type refrigeration cycle 10 of the present embodiment, he module side connection portion of the intake pipe 15c and the module side connection portion of the downstream side high-pressure pipe 15b are shaped to extend along the fire wall 50. Therefore, a dimension (the amount of protrusion) by which the intake pipe 15c and the downstream side high-pressure pipe 15b protrude from the fire wall 50 toward the engine room 61 side can be reduced.

According to the above configuration, when placing an equipment such as the engine 70 in the engine room 61, interference between the intake pipe 15c and the downstream side high-pressure pipe 15b can be reduced, and the space in the engine room 61 can be effectively leveraged.

Incidentally, against the present embodiment, as illustrated in FIG. 6, the module side connection portion of the outlet pipe 15e and the module side connection portion of the inlet pipe 15d may be shaped to extend along the fire wall 50. According to that configuration, the space in the vehicle compartment can be effectively leveraged.

Further, the module side connection portion of the intake pipe 15c and the module side connection portion of the downstream side high-pressure pipe 15b may be shaped to extend along the fire wall 50, and the module side connection portion of the outlet pipe 15e and the module side connection portion of the inlet pipe 15d may be shaped to extend along the fire wall 50.

### Fourth Embodiment

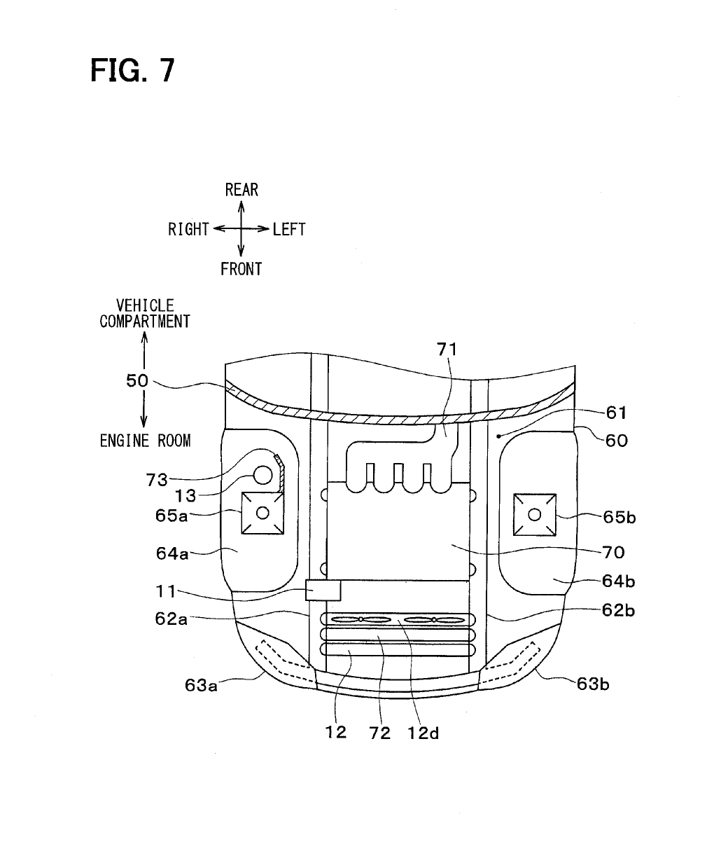

In the present embodiment, against the first embodiment, as illustrated in FIG. 7, a heat shield plate 73 that suppresses a heat transfer from the engine 70 to the ejector module 13 is disposed between the ejector module 13 and the engine 70 in the engine room 61. The heat shield plate 73 made of resin or metal can be employed.

The other configurations of the ejector-type refrigeration cycle 10 are identical with those in the first embodiment. Therefore, when the vehicle air conditioning apparatus according to the present embodiment is actuated, the air conditioning in the vehicle compartment can be realized as in the first embodiment.

In addition, according to the ejector-type refrigeration cycle 10 of the present embodiment, since the heat shield plate 73 is disposed, absorption of a radiant heat of the engine 70 by the liquid-phase refrigerant separated by the gas-liquid separation space 30f of the ejector module 13 can be reduced. The liquid-phase refrigerant can be effectively suppressed from absorbing the heat in the engine room 61 when flowing in the inlet pipe 15d. Therefore, a reduction in the refrigeration performance delivered by the evaporator 14 can be suppressed.

The present invention is not limited to the above-described embodiments, but various modifications can be made thereto as follows without departing from the spirit of the present invention. The device disclosed in the respective embodiments may be appropriately combined together in an implementable range. For example, the heat shield plate 73 described in the fourth embodiment may be applied to the ejector-type refrigeration cycle 10 described in the second and third embodiments.

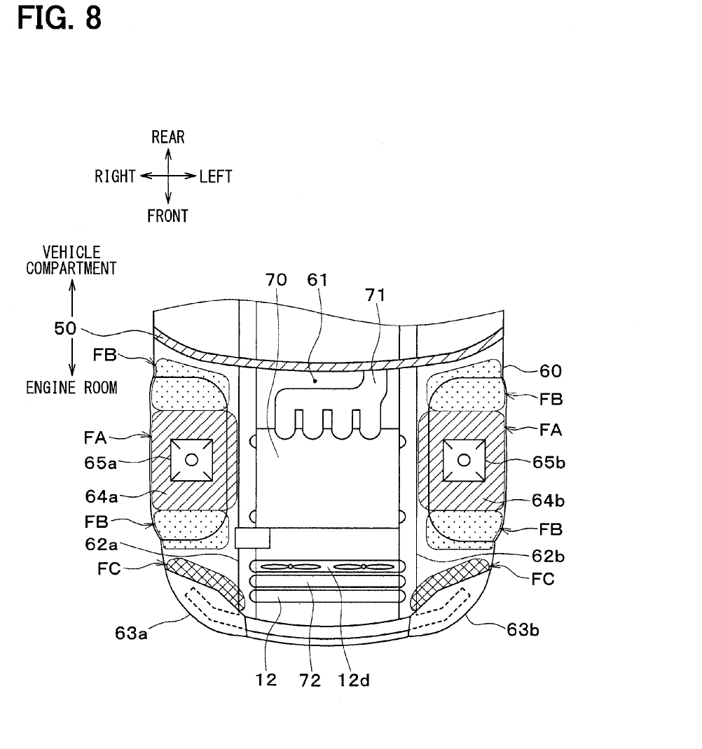

In the first embodiment described above, as a specific example of the placement of the ejector module 13, the ejector module 13 is placed on the rear side of the right suspension tower 65a. However, the placement of the ejector module 13 is not limited to the above placement. For example, the ejector module 13 may be placed in areas (areas indicated by shaded hatchings FA in FIG. 8) close to the right suspension tower 65a and the left suspension tower 65b.

Further, the ejector module 13 may be placed in each of areas (areas indicated by mesh hatchings FC in FIG. 8) close to the mounting portion of the reflector of the right headlight 63a and the mounting portion of the reflector of the left headlight 63b. The ejector module 13 may be placed in the vicinity of the fire wall 50. The ejector module 13 may be placed in each of areas close to the right tire house 64a and the left tire house 64b (areas indicated by dot hatchings FB in FIG. 8).

In this example, as described in the above embodiments, that the ejector module 13 is placed in the vicinity of the fire wall 50 or the tire houses 64a, 64b means that the ejector module 13 is placed closer to each of the tire houses 64a and 64b than the engine 70 or the ejector module 13 is disposed so that the shortest distance between the ejector module 13 and each of the tire houses 64a and 64b, or the like falls within 10 cm.

Also, against the embodiments described above, in a vehicle having a front exhaust type engine in the engine room 61, the ejector module 13 may be disposed in each of areas on the rear side of the right tire house 64a and the left tire house 64b, or on the fire wall 50 side as in the third embodiment. With the above configuration, the same advantages as those in the above second embodiment can be obtained.

In addition, against the embodiments described above, for example, as in a rear-wheel drive vehicle and an all-wheel drive vehicle, in the vehicle where the crankshaft of the engine 70 extend in the front-rear direction of the vehicle, and the exhaust pipe 71 is connected to one surface of the engine 70 in the lateral width direction when viewed from the vehicle top side, the ejector module 13 may be placed at a position away from the exhaust pipe 71 more than the other surface. With the above configuration, the same advantages as those in the above second embodiment can be obtained.

In other words, the ejector module 13 may be placed at a position unlikely to be affected by the engine waste heat according to a type or kind of the engine. According to the present inventors' study, it is confirmed that if the ejector module 13 is disposed in an area of 160° C. or lower in the engine room 61, more preferable in an area of 100° C. or lower, a reduction in the refrigeration performance delivered by the evaporator 14 can be sufficiently suppressed.

In the first embodiment described above, the example in which the length of the inlet pipe 15d is shorter than the length of the intake pipe 15c has been described. However, it is sufficient that, of the inlet pipe 15d, a length of a pipe extending from the liquid-phase refrigerant outflow port 31c of the ejector module 13 to the connector 51 of the fire wall 50 is shorter than the length of the intake pipe 15c. With the above configuration, absorption of the heat in the engine room 61 by the liquid-phase refrigerant that flows in the inlet pipe 15d can be reduced.

The respective configuration devices configuring the ejector-type refrigeration cycle 10 are not limited to those disclosed in the above embodiments.

For example, in the above embodiments, the example in which the variable capacity type compressor is employed as the compressor 11 has been described. However, the compressor 11 is not limited to the above configuration. For example, as the compressor 11, a fixed capacity type compressor which is driven by a rotational drive force output from the engine 70 through an electromagnetic clutch, a belt, and so on may be employed. In a fixed capacity type compressor, an operation rate of the compressor may be changed by intermittent operation of the electromagnetic clutch to adjust the refrigerant discharge capacity. Also, as the compressor 11, an electric compressor that adjusts the refrigerant discharge capacity while changing the rotational speed of an electric motor may be employed.

Further, the compressor 11 may be fixed to a left side or a rear side of the engine 70 according to the type or kind of the engine.

In addition, in the above-described embodiments, examples in which a subcooling heat exchanger is employed as the radiator 12 have been described, but, it is needless to say that a normal radiator formed of only the condensing portion 12a may be employed as the radiator 12. Further, with a normal radiator, a liquid receiver (receiver) that separates the refrigerant radiated by the radiator into gas and liquid, and stores an excess liquid-phase refrigerant may be employed.

In addition, in the embodiments described above, the example in which the body portion 30 of the ejector module 13 is formed into the cylindrical shape has been described, but the body portion 30 may be formed into a prismatic shape. The components of the body portion 30, the passage formation member 35, and so on of the ejector module 13 are not limited to metal, but may be made of resin.

In the above embodiments, the example in which the ejector-type refrigeration cycle 10 of the present disclosure is applied to the vehicle air conditioning apparatus has been described, but the application of the ejector-type refrigeration cycle 10 of the present disclosure is not limited to the above configuration. For example, the ejector-type refrigeration cycle 10 may be applied to a vehicle freezing and refrigerating device.

The present disclosure has been described based on the embodiments; however, it is understood that this disclosure is not limited to the embodiments or the structures. The present disclosure includes various modification examples, or modifications within an equivalent range. In addition, various combinations or forms, and other combinations or forms including only one element, more than or less than one among these combinations or forms are included in the scope or the technical scope of the present disclosure.

What is claimed is:

1. An ejector-type refrigeration cycle for a vehicle, comprising:
a compressor that compresses and discharges a refrigerant;
a radiator that radiates heat of the refrigerant discharged from the compressor;
an ejector module including a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; and a gas-liquid separation portion which separates the refrigerant that has flowed out of the pressure increase portion into gas and liquid; and
an evaporator that evaporates a liquid-phase refrigerant separated by the gas-liquid separation portion; wherein
the compressor and the radiator are disposed in an engine room that is positioned outside a vehicle compartment and is a space in which an internal combustion engine is disposed,
the evaporator is disposed in the vehicle compartment, and
the ejector module is disposed outside an area that overlaps with the internal combustion engine when viewed from a vehicular upper side.

2. An ejector-type refrigeration cycle for a vehicle, comprising:
a compressor that compresses and discharges a refrigerant; a radiator that radiates heat of the refrigerant discharged from the compressor;
an ejector module including a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; and a gas-liquid separation portion which separates the refrigerant that has flowed out of the pressure increase portion into gas and liquid; and
an evaporator that evaporates a liquid-phase refrigerant separated by the gas-liquid separation portion; wherein
the compressor and the radiator are disposed in an engine room that is positioned outside a vehicle compartment and is a space in which an internal combustion engine is disposed,
the evaporator is disposed in a vehicle compartment, and
the ejector module is disposed outside an area that overlaps with the internal combustion engine when viewed from a vehicular front side.

3. The ejector-type refrigeration cycle according to claim 2, wherein
the internal combustion engine is located between and fitted to a pair of side members that is a structural member of the vehicle and extends in a front-rear direction of the vehicle, and
the ejector module is disposed outside the side members when viewed from the vehicular front side.

4. An ejector-type refrigeration cycle for a vehicle, comprising:
a compressor that compresses and discharges a refrigerant;
a radiator that radiates heat of the refrigerant discharged from the compressor;
an ejector module including a body portion that includes: a nozzle portion which reduces a pressure of the refrigerant which has flowed out of the radiator; a refrigerant suction port which draws a refrigerant by a suction action of an ejection refrigerant ejected at high speed from the nozzle portion; a pressure increase portion which mixes the ejection refrigerant with a drawn refrigerant drawn from the refrigerant suction port and increases a pressure of the mixed refrigerant; and a gas-liquid separation portion which separates the refrigerant that has flowed out of the pressure increase portion into gas and liquid; and
an evaporator that evaporates a liquid-phase refrigerant separated by the gas-liquid separation portion; wherein
the compressor and the radiator are disposed in an engine room that is positioned outside a vehicle compartment and is a space in which an internal combustion engine is disposed,
the evaporator is disposed in the vehicle compartment, and
the ejector module is disposed at a position farther from the exhaust pipe than a surface of the internal combustion engine opposite from a side to which the exhaust pipe is attached, when viewed from a vehicular upper side.

5. The ejector-type refrigeration cycle according to claim 1, further comprising a heat shield plate that reduces a heat transfer from the internal combustion engine to the ejector module.

6. The ejector-type refrigeration cycle according to claim 2, further comprising a heat shield plate that reduces a heat transfer from the internal combustion engine to the ejector module.

7. The ejector-type refrigeration cycle according to claim 4, further comprising a heat shield plate that reduces a heat transfer from the internal combustion engine to the ejector module.
